(19) United States
(12) Patent Application Publication
(10) Pub. No.: US 2026/0177267 A1
(43) Pub. Date: Jun. 25, 2026

(54) SERVER AND CONTROLLING METHOD THEREOF

(71) Applicant: Samsung Electronics Co., Ltd., Suwon-si (KR)

(72) Inventors: Sookyung KIM, Suwon-si (KR); Cholok HAN, Suwon-si (KR); Yerim HAN, Suwon-si (KR); Kwanwoo SONG, Suwon-si (KR); Ki MIN, Suwon-si (KR); Kyungjae KIM, Suwon-si (KR); Minseong KANG, Suwon-si (KR)

(21) Appl. No.: 19/432,677

(22) Filed: Dec. 24, 2025

Related U.S. Application Data
(63) Continuation of application No. PCT/KR2025/021738, filed on Dec. 15, 2025.

(30) Foreign Application Priority Data
Dec. 19, 2024 (KR) 10-2024-0191723

(51) Int. Cl. F24F 11/58; F24F 11/65; F24F 110/10; F24F 110/20; H04W 4/33

(52) U.S. Cl. CPC F24F 11/58; F24F 11/65; H04W 4/33; F24F 2110/10; F24F 2110/20

(57) ABSTRACT

A server is provided. The server includes processing circuitry, memory, comprising one or more storage media, storing instructions, and at least one processor communicatively coupled to the processing circuitry and the memory, wherein the instructions, when executed by the at least one processor individually or collectively, cause the server to identify a central control device and at least one individual control devices arranged in an indoor space as at least one group, identify a control mode corresponding to a first group among the identified at least one group, based on sensing information corresponding to the first group and a target temperature corresponding to the indoor space, and control a device included in the first group based on the identified control mode.

### CROSS REFERENCE TO RELATED APPLICATION(S)

This application is a continuation application, claiming priority under 35 U.S.C. § 365(c), of an International application No. PCT/KR2025/021738, filed on Dec. 15, 2025, which is based on and claims the benefit of a Korean patent application number 10-2024-0191723, filed on Dec. 19, 2024, in the Korean Patent Office, the disclosure of which is incorporated by reference herein in its entirety.

### BACKGROUND

### 1. Field

The disclosure relates to apparatuses and methods consistent with a server and a controlling method thereof. More particularly, the disclosure relates to a server and a controlling method thereof for controlling a plurality of air handling units arranged in an indoor space.

### 2. Description of Related Art

With the development of electronic technology, various types of electronic devices have been developed and distributed. Recently, various air handling units have been developed for arrangement in indoor spaces to perform functions such as air purification, ventilation, humidity control, cooling, or heating.

When a central air conditioning system, which processes air in a single device and provides heating and cooling to the entire building through ducts, and a split system air conditioner, which provides individual cooling to each space in a form in which indoor unit and outdoor unit are separated, are installed in the same space and perform the above-described functions, a method for efficiently operating each air handling unit is needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a server and a controlling method.

Additional aspects will be set forth in part in the description which follows and, in part, will be apparent from the description, or may be learned by practice of the presented embodiments.

In accordance with an aspect of the disclosure, a server is provided. The server includes processing circuitry, memory, comprising one or more storage media, storing instructions, at least one processor communicatively coupled to the processing circuitry and the memory, wherein the instructions, when executed by the at least one processor individually or collectively, cause the server to identify a central control device and at least one individual control device arranged in an indoor space as at least one group, identify a control mode corresponding to a first group among the identified at least one group, based on sensing information corresponding to the first group and a target temperature corresponding to the indoor space, and control a device included in the first group based on the identified control mode.

In accordance with another aspect of the disclosure, an operating method of a server is provided. The operating method includes identifying a central control device and at least one individual control device arranged in an indoor space as at least one group, identifying a control mode corresponding to a first group among the identified at least one group, based on sensing information corresponding to the first group and a target temperature corresponding to the indoor space, and controlling a device included in the first group based on the identified control mode.

In accordance with another aspect of the disclosure, one or more non-transitory computer-readable storage media storing one or more computer programs including computer-executable instructions that, when executed by at least one processor of a server individually or collectively, cause the server to perform operations are provided. The operations include identifying a central control device and at least one individual control device arranged in an indoor space as at least one group, identifying a control mode corresponding to a first group based on sensing information corresponding to the first group and a target temperature corresponding to the indoor space and controlling a device included in the first group based on the identified control mode.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram for schematically describing a server according to an embodiment of the disclosure;

FIG. 2 is a block diagram illustrating a configuration of the server according to an embodiment of the disclosure;

FIG. 3 is a flowchart for describing an operating method of a server according to an embodiment of the disclosure;

FIG. 4 is a diagram illustrating a method of identifying at least one group according to an embodiment of the disclosure;

FIG. 5 is a flowchart illustrating a method of identifying a control mode according to an embodiment of the disclosure;

FIG. 6 is a flowchart for describing the method of identifying a control mode according to an embodiment of the disclosure;

FIG. 7 is a flowchart for describing the method of identifying a control mode according to an embodiment of the disclosure;

FIG. 8 is a flowchart for describing a method of identifying a level of a device included in a first group according to an embodiment of the disclosure;

FIG. 9 is a flowchart for describing an operation for controlling a device based on a level according to an embodiment of the disclosure;

FIG. 10 is a flowchart for describing a method of identifying one control mode based on a control mode setting value according to an embodiment of the disclosure;

FIG. 11 is a flowchart for describing a method of performing a feedback operation according to an embodiment of the disclosure;

FIG. 12 is a flowchart for describing a method of controlling a device based on an average value of temperature information of indoor air according to an embodiment of the disclosure;

FIGS. 13A, 13B, 13C and 13D are diagrams for describing a control method in an outdoor air cooling mode according to various embodiments of the disclosure;

FIGS. 14A, 14B and 14C are diagrams illustrating a control method in a latent heat mode according to various embodiments of the disclosure;

FIGS. 15A, 15B and 15C are diagrams for describing a control method in a high sensible heat mode according to various embodiments of the disclosure;

FIG. 16 is a flowchart for describing a method of identifying a first group according to an embodiment of the disclosure;

FIG. 17 is a block diagram for describing a central air conditioning system type device according to an embodiment of the disclosure; and

FIG. 18 is a block diagram illustrating a detailed configuration of a server according to an embodiment of the disclosure.

The same reference numerals are used to represent the same elements throughout the drawings

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms that are currently widely used were selected as terms used in embodiments of the disclosure in consideration of functions in the disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in the disclosure should be defined on the basis of the meaning of the terms and the contents throughout the disclosure rather than simple names of the terms.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first,” “second,” “1st” or “2nd” or the like, used in the specification may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

Singular expressions are intended to include plural expressions unless the context clearly indicates otherwise. It will be understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

In the disclosure, a “module” or a “˜er/or” may perform at least one function or operation, and be implemented by hardware or software or be implemented by a combination of hardware and software. In addition, a plurality of “modules” or a plurality of “˜ers/˜ors” may be integrated in at least one module and be implemented by at least one processor (not illustrated) except for a “module” or a “˜er/or” that needs to be implemented by specific hardware.

The term “signal” includes not only an electrical signal but also a sound wave signal, and the electrical signals may be either an analog signal or a digital signal. For example, the expression “audio signal” (or “noise signal”) refers to a sound wave (or radio) signal when the signal is located outside the server, or an electrical signal when the signal is located inside the server. In addition, signal processing, etc., within the server, as described below, may be digital, analog, or a combination of analog and digital signal processing.

In this specification, the term “filter” refers to removing a specific component (e.g., a specific frequency range or a specific pattern). The filter may be a digital or analog filter.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

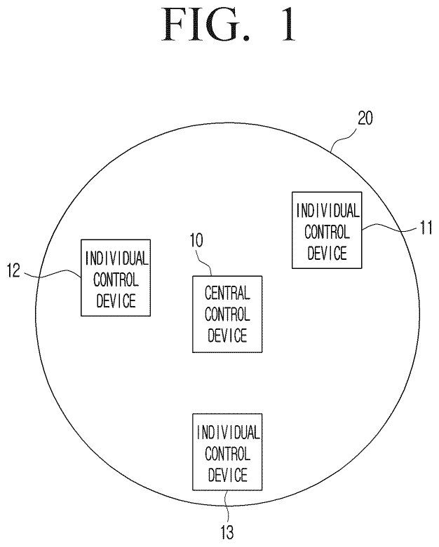

FIG. 1 is a diagram for schematically describing a server according to an embodiment of the disclosure.

Referring to FIG. 1, according to an embodiment, at least one device capable of performing an air conditioning function may be arranged in an indoor space. According to one example, different types of devices, including a central control device 10 and individual control devices 11, 12, and 13, may be arranged in the indoor space.

According to one example, the central control device may be included in an air handling unit of a central air conditioning system type. According to one example, the individual control devices may be configured to be included in an air handling unit of a different type from the central air conditioning system.

A server 100 may group at least one device arranged in the indoor space. According to one example, the server 100 may identify a group including devices 11, 12, and 13 located within a preset distance 20 from the central control device 10. For example, the server 100 may identify the central control device 10 as a leader device and identify a group including the devices 11, 12, and 13 located within a preset distance 20 from the leader device.

According to one example, the server 100 may identify a control mode corresponding to the identified group. For example, the server 100 may acquire environmental information about the indoor space and surrounding space (e.g., information on temperature and humidity of the indoor space, temperature and humidity of air supplied to the indoor space, or temperature and humidity of outdoor air) from the identified group. The server 100 may identify the control mode corresponding to the identified group based on the acquired environmental information.

According to an embodiment, the server 100 may control the devices included in the group based on the control mode corresponding to the identified group. According to one example, when the control mode is identified, the server 100 may control each device based on the type of device included in the group. For example, when the control mode is identified, the server 100 may control the central control device based on a setting value corresponding to the central control device, and control the individual control devices based on setting values corresponding to the individual control devices.

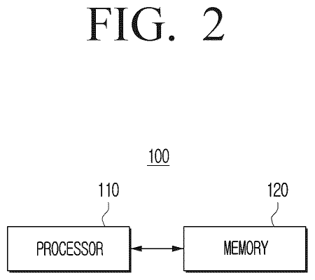

FIG. 2 is a block diagram illustrating a configuration of the server according to an embodiment of the disclosure.

Referring to FIG. 2, the server 100 may include at least one processor 320 and memory 120.

According to another embodiment, the server 100 may be implemented as a cloud server, but is not limited thereto. According to an embodiment, the server 100 may be a server installed within a building where the air handling unit is arranged. According to another embodiment, the server 100 may perform an operation based on a signal received from an external device (e.g., a user terminal receiving user input, etc.).

Meanwhile, according to one example, the operations of the server 100 to be described below, may also be performed by an external device (e.g., the user terminal, etc.). For example, the control mode may be identified from the external device, and the external device may directly transmit a control signal related thereto to at least one device present in the indoor space, or may transmit the control signal through the server 100. However, for convenience of description, the following description is described as being limited to an embodiment in which the server 100 performs overall operations.

At least one processor 110 (hereinafter, “processor”) is electrically connected to the memory 120 and controls the overall operations of the server 100. The processor 110 may be composed of one or a plurality of processors. Specifically, the processor 110 may perform an operation of the server 100 according to various embodiments of the disclosure by executing at least one instruction stored in the memory 120.

The processor 110 may be implemented by a digital signal processor (DSP) that processes a digital image signal, a microprocessor, a graphics processing unit (GPU), an artificial intelligence (AI) processor, a neural processing unit (NPU), or a time controller (TCON). However, the processor 110 is not limited thereto, and may include one or more of a central processing unit (CPU), a micro controller unit (MCU), a micro processing unit (MPU), a controller, an application processor (AP), a communication processor (CP), and an ARM processor, or may be defined by these terms. In addition, the processor 110 may be implemented by a system-on-chip (SoC) or a large scale integration (LSI) in which a processing algorithm is embedded, or may be implemented in the form of an application specific integrated circuit (ASIC) and a field programmable gate array (FPGA).

The memory 120 may store data necessary for various embodiments. The memory 120 may be implemented in a form of memory embedded in the server 100 or a form of memory attachable to and detachable from the server 100, depending on a data storage purpose. For example, data for driving the server 100 may be stored in the memory embedded in the server 100, and data for an extension function of the server 100 may be stored in the memory attachable to and detachable from the server 100.

The memory embedded in the server 100 may be implemented in at least one of, for example, a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, and a solid state drive (SSD)). In addition, the memory attachable to and detachable from the server 100 may be implemented in the form of the memory card (e.g., compact flash (CF), secure digital (SD), micro secure digital (Micro-SD), mini secure digital (Mini-SD), extreme digital (xD), multi-media card (MMC), etc.), external memory (e.g., USB memory) connectable to a USB port, and the like.

According to an embodiment, the processor 110 may identify a central control device and the individual control devices arranged in the indoor space as at least one group. According to one example, at least one central control device and at least one individual control device may be arranged in the indoor space.

The central control device may be configured to be included in the air handling unit of a central air conditioning system type. According to one example, the central control device may be a device that regulates the amount of air supplied from the central air conditioning system to the indoor space, such as a variable air volume unit. According to one example, the central control device may be arranged in the indoor space. However, the central control device is not limited thereto. According to one example, it goes without saying that the central control device may be implemented as any one of the devices configuring the central air conditioning system.

According to one example, at least one central control device arranged in the indoor space may be a device included in a single central air conditioning system. However, the central control device is not limited thereto, and it goes without saying that each central control device may be a device correspond to a different central air conditioning system.

In an example, the central control device arranged in the indoor space may have a separate control unit, and each central control device may operate independently, but the disclosure is not limited thereto. For example, at least one central control device may be a device that operates based on the control signal received from the central air conditioning system.

According to another example, the individual control devices may be configured to be included in a different type of device than the central air conditioning system. According to one example, the device corresponding to the individual control device may be a device (e.g., a wall-mounted air conditioner, a stand-alone air conditioner, or a split system air conditioner) that independently (or individually) performs an air conditioning operation. According to one example, the individual control devices may be implemented as an indoor unit (IDU), but the disclosure is not limited thereto. According to one example, at least one individual control device arranged in the indoor space may operate independently.

According to an embodiment, the processor 110 may group at least one central control device and at least one individual control device arranged in the indoor space into at least one group. For example, the processor 110 may identify devices (e.g., the central control device or the individual control devices) located within a preset distance from a first central control device among at least one central control device arranged in the indoor space as a first group. Alternatively, the processor 110 may identify devices located within a preset distance from a second central control device among at least one central control device arranged in the indoor space as a second group. According to one example, the devices arranged in the indoor space may be included in a plurality of groups.

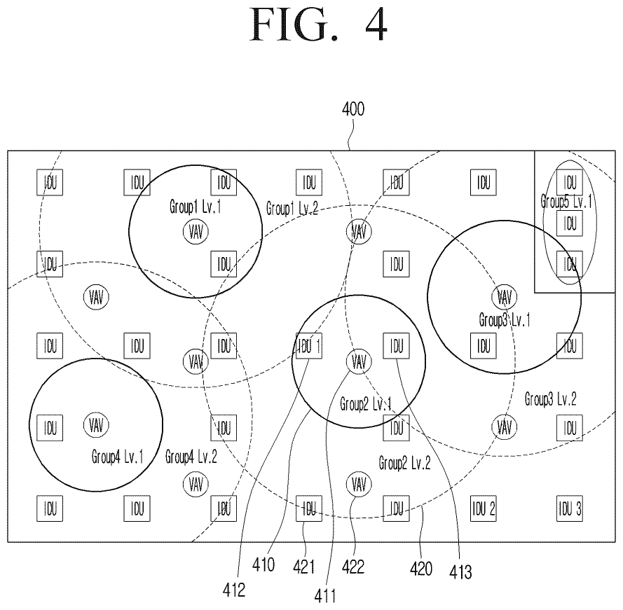

The leader device corresponding to each group may exist. According to one example, the leader device may be implemented as the central control device, but is not limited thereto. According to one example, the leader device may be a device designated based on the user input, but is not limited thereto. Meanwhile, a specific method for identifying at least one group will be described in detail with reference to FIG. 4.

According to an embodiment, the processor 110 may identify the control mode corresponding to the first group among at least one group. According to one example, when sensing information corresponding to the first group among at least one identified group is acquired, the processor 110 may identify the control mode corresponding to the first group based on the acquired sensing information and a target temperature corresponding to the indoor space.

The processor 110 may acquire the sensing information from the central control device. For example, the processor 110 may acquire, from the central control device, at least one of the temperature information of air (or indoor air) corresponding to the indoor space, the humidity information of the indoor air, the temperature information of air (or supply air) supplied from the central control device to the indoor space, humidity information of the supply air, temperature information of mixed air, and humidity information of the mixed air. Alternatively, according to one example, the processor 110 may acquire the above-described sensing information from the central air conditioning system corresponding to the central control device. Alternatively, it goes without saying that the processor 110 may also acquire the above-described information from the external device (e.g., an external server) other than the central air conditioning system. Meanwhile, according to an example, the mixed air may be a mixture of the outdoor air (outside air) and indoor air that flows into a central air handling unit (or air handling unit, AHU) corresponding to the central control device. Alternatively, the mixed air may be the outdoor air that flows into the outdoor air handling unit corresponding to the central control device.

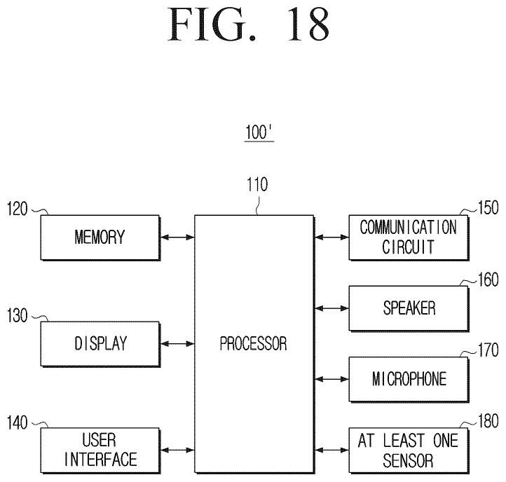

According to one example, the processor 110 may further include a communication circuit (e.g., a communication circuit 150 of FIG. 18), and the processor 110 may acquire the sensing information from at least one of the central control device and the individual control devices through the communication circuit. However, the disclosure is not limited thereto, and it goes without saying that, according to one example, the processor 110 may acquire sensing information from devices other than the central control device and the individual control devices.

The processor 110 may acquire the sensing information from the individual control devices. For example, the processor 110 may acquire at least one of the temperature information of the indoor air, the humidity information of the indoor air, the temperature information of the supply air, and the humidity information of the supply air from the individual control devices. Alternatively, according to one example, the processor 110 may acquire the above-described sensing information from the outdoor unit corresponding to the individual control devices. Alternatively, it goes without saying that the processor 110 may acquire the above-described information from the external device (e.g., the external server) other than the above-described devices.

According to another embodiment, the sensing information corresponding to the first group may be information sensed by each of at least one device (the central control device or the individual control devices) included in the first group. Alternatively, the sensing information corresponding to the first group may be information sensed by the system (e.g., the central air conditioning system) including at least one device included in the first group.

According to one example, the control mode may be an operating mode for controlling at least one device included in the identified group. For example, the control mode may be any one of an outdoor air cooling mode, a latent heat mode, or a high sensible heat mode, but is not limited thereto. According to one example, the control mode may be a mode in which each device operates at an operating intensity corresponding to a type (e.g., a central control device type or an individual control device type) of device included in the group. Each control mode will be described below.

The processor 110 may acquire the target temperature corresponding to the indoor space. According to one example, the processor 110 may acquire the target temperature based on the user input. According to one example, the processor 110 may receive the user input related to the target temperature from the external device (e.g., the user terminal). Alternatively, for example, the processor 110 may receive the user input for controlling the devices arranged in the indoor space from the external device.

According to one example, the processor 110 may identify the control mode corresponding to the first group based on the acquired sensing information corresponding to the first group and the target temperature corresponding to the indoor space. The processor 110 may acquire the temperature information and humidity information of the outdoor air from the central control device included in the first group. The processor 110 may calculate a first enthalpy based on the acquired target temperature and a second enthalpy based on the acquired temperature and humidity information of the outdoor air. The processor 110 may compare magnitudes of the first enthalpy and the second enthalpy, and when it is identified that a first enthalpy value exceeds a second enthalpy value by a preset value or greater, the processor 110 may identify the outdoor air cooling mode among the plurality of control modes. The processor 110 may identify the identified outdoor air cooling mode based on the control mode corresponding to the first group. A specific method for identifying the control mode will be described below.

According to one embodiment, the processor 110 may control the devices included in the first group based on the identified control mode. According to one example, when the control mode is identified, the processor 110 may control the devices included in the first group based on the identified control mode. According to one example, the processor 110 may control each device based on the type of device included in the first group. For example, the processor 110 may control the leader device among the devices included in the first group to operate at a ‘minimum airflow’, the central control device type among the devices other than the leader device to operate at the ‘minimum airflow’, and the individual control device type among the devices other than the leader device to be turned off.

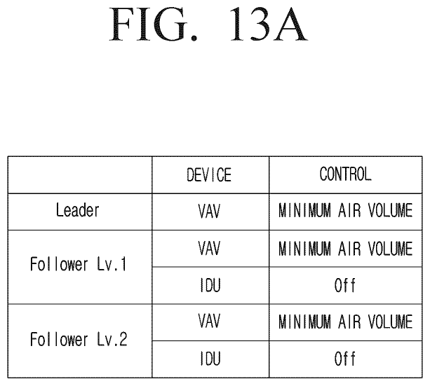

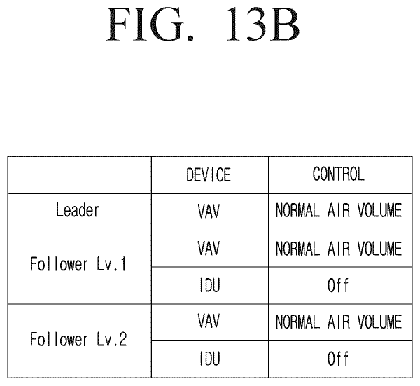

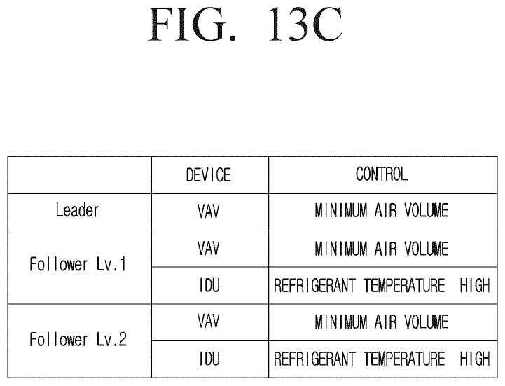

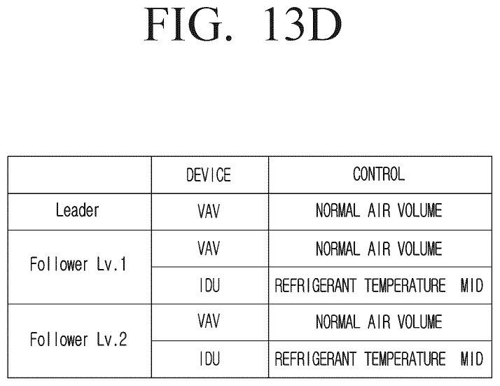

According to one example, when the control mode is identified, the processor 110 may control each device to perform different operations based on the temperature of the indoor air corresponding to the first group and the target temperature. This will be described in detail with reference to FIGS. 13A to 13D, 14A to 14C, and 15A to 15C.

According to one example, the processor 110 may transmit the control signal corresponding to each control mode to the device corresponding to the first group via the communication circuit. Alternatively, according to one example, it goes without saying that the processor 110 may transmit the control signal to a central control unit (e.g., the air handling unit) corresponding to each device.

When multiple types of air handling units (e.g., the central air conditioning system and the split system air conditioner) are installed in the indoor space, the server 100 groups each air handling unit and sets the control mode corresponding to each group based on information acquired from each group, thereby performing the air conditioning function more efficiently than when each air handling unit operates independently.

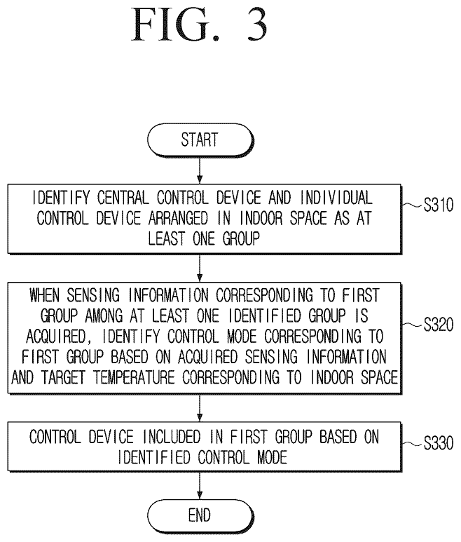

FIG. 3 is a flowchart for describing an operating method of a server according to an embodiment of the disclosure.

Referring to FIG. 3, according to an embodiment, the operating method may include an operation S310 of identifying the central control device and the individual control devices arranged in the indoor space as at least one group.

According to one example, the server 100 may identify the central control device and the individual control devices arranged in the indoor space as at least one group. According to one example, at least one central control device and at least one individual control device may be arranged in the indoor space. According to one example, the server 100 may identify at least one device within the indoor space as the leader device and identify devices present within a preset distance from each leader device as the group corresponding to the leader device.

According to an embodiment, the operating method may include, when the sensing information corresponding to the first group among the at least one identified group is acquired, identifying the control mode corresponding to the first group based on the acquired sensing information and the target temperature corresponding to the indoor space at operation S320.

According to one example, when the sensing information corresponding to the first group among at least one identified group is acquired, the server 100 may identify the control mode corresponding to the first group based on the acquired sensing information and the target temperature corresponding to the indoor space. According to an embodiment, when at least one group is identified, the server 100 may acquire the sensing information from the device corresponding to the first group among the identified groups. According to one example, the server 100 may identify the target temperature corresponding to the indoor space from the external device (e.g., the user terminal).

Alternatively, the server 100 may acquire the target temperature via the leader device. For example, the leader device may include a user interface, and the server 100 may acquire the target temperature based on the user input received via the leader device.

According to one example, the server 100 may identify the control mode corresponding to the first group based on the acquired sensing information and target temperature.

According to another embodiment, the operating method may include an operation S330 of controlling the devices included in the first group based on the identified control mode. According to one example, the server 100 may control the devices included in the first group based on the identified control mode.

FIG. 4 is a diagram illustrating a method of identifying at least one group according to an embodiment of the disclosure.

Referring to FIG. 4, according to an embodiment, a plurality of central control devices (‘VAVs’) and a plurality of individual control devices (‘IDUs’) may be arranged in the indoor space 400. According to one example, while FIG. 4 illustrates the central control device as a ‘VAV’ and the individual control devices as ‘IDUs’, the central control device is limited to a variable air volume unit or that the individual control devices are limited to the indoor unit.

According to one example, the server 100 may identify at least one leader device (e.g., a first leader device 411). According to one example, the server 100 may identify the leader device among the central control devices, but the disclosure is not limited thereto. According to one example, it goes without saying that the leader device may also be identified among the individual control devices.

According to one example, the server 100 may identify at least one leader device based on the user input. Alternatively, the server 100 may identify at least one leader device based on a preset condition. For example, it goes without saying that the server 100 may also identify the leader device arbitrarily.

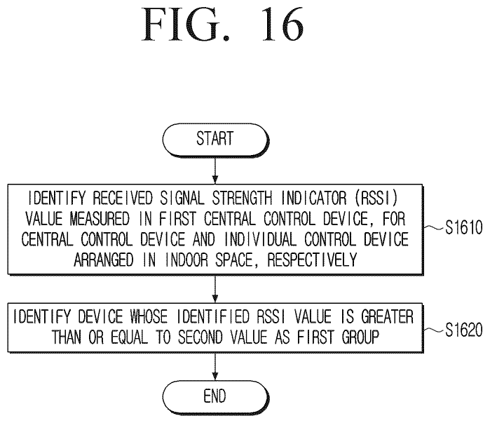

When at least one leader device is identified, the server 100 may identify at least one device corresponding to the identified leader device based on a preset condition. For example, when the first leader device 411 is identified, the server 100 may identify devices present within a preset second distance 420 from the first leader device 411 as “group 2.” However, the disclosure is not limited thereto, and for example, the server 100 may identify a device whose received signal strength indicator (RSSI) value measured by the first leader device 411 is greater than or equal to a preset value as ‘group 2’. This will be described in detail with reference to FIG. 16.

According to one example, the server 100 may identify a level corresponding to each of at least one device included in ‘group 2’. For example, the server 100 may identify a level of a device (e.g., an individual control device 412 and an individual control device 413) located within a first distance 410 from the first leader device 411 as a first level. For example, the server 100 may identify the level of the device (e.g., an individual control device 421 and a central control device 422) located at the first distance 410 or greater and within the second distance 420 from the first leader device 411 as a second level.

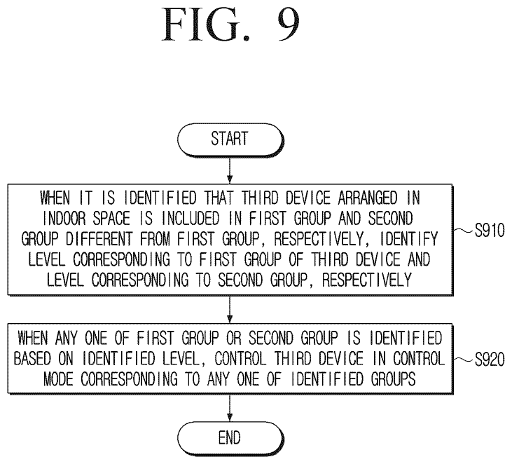

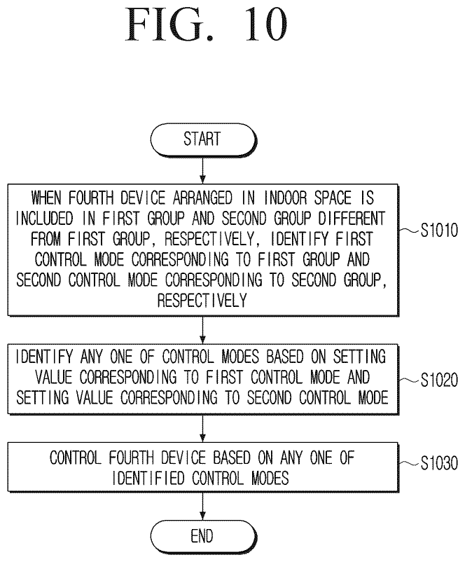

Each device may be included in at least one group. For example, the first individual control device 412 may be included in ‘group 1’ and ‘group 2’, respectively. The first individual control device 412 may be identified as level 2 for ‘group 1’ and as level 1 for ‘group 2’. A specific method for identifying the control mode of the devices included in the plurality of groups will be described in detail with reference to FIGS. 9 and 10.

According to one example, there may be a group that does not include the leader device. For example, ‘group 5’ may be a set of the individual control devices whose distance from the central control device exceeds a preset value. The devices included in ‘group 5’ may not operate in the control mode corresponding to the group, but each device may operate independently.

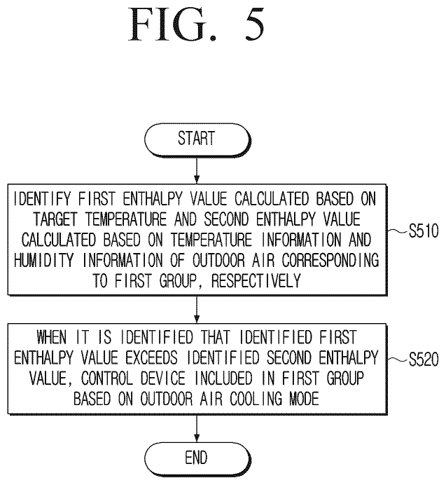

FIG. 5 is a flowchart illustrating a method for identifying a control mode according to an embodiment of the disclosure.

Referring to FIG. 5, according to an embodiment, the operating method may include an operation S510 of identifying the first enthalpy value calculated based on the target temperature and the second enthalpy value calculated based on the temperature and the humidity information of the outdoor air corresponding to the first group.

According to one example, the server 100 may calculate the first enthalpy based on the target temperature corresponding to the indoor space. For example, the server 100 may calculate the first enthalpy using the target temperature corresponding to the indoor space and the target humidity corresponding to the indoor space. According to one example, the target humidity may be relative humidity, but is not limited thereto, and it goes without saying that the target humidity may also be absolute humidity. According to one example, when the target humidity is not acquired, the server 100 may calculate the first enthalpy as a preset value (e.g., 40%).

According to an embodiment, the server (100) may acquire the second enthalpy value based on the temperature information and the humidity information of the outdoor air corresponding to the first group. According to one example, the sensing information may include at least one of the temperature information and the humidity information of the outdoor air corresponding to the first group. According to one example, the outdoor air corresponding to the first group may be the outdoor air flowing into the central air handling unit (or air handling unit (AHU)) corresponding to the central control devices included in the first group, but is not limited thereto. According to one example, when the plurality of central control devices are included in the first group, the temperature information and the humidity information of the outdoor air may be the temperature information and the humidity information of the outdoor air corresponding to the leader device, but is not limited thereto, and according to an example, may of course be an average value of the temperature information and the humidity information of the outdoor air corresponding to each of the plurality of central control devices.

According to an embodiment, the operating method may include an operation S520 of controlling the devices included in the first group based on the outdoor air cooling mode when the identified first enthalpy value is determined to exceed the identified second enthalpy value.

The server 100 may compare the identified first enthalpy value with the identified second enthalpy value. For example, the server 100 may use the identified first enthalpy value and the identified second enthalpy value to determine whether the following Mathematical Expression 1 is satisfied.

$$A + b > C \qquad [ Mathematical Expression 1 ]$$

In the above Mathematical Expression, ‘A’ may be the first enthalpy value and ‘C’ may be the second enthalpy value. According to one example, ‘b’ may be a positive margin. According to one example, when it is determined that the above-described Mathematical Expression 1 is satisfied, the server 100 may identify that the identified first enthalpy value exceeds the identified second enthalpy value. According to one example, when it is determined that the identified first enthalpy value exceeds the identified second enthalpy value, the server 100 may identify the outdoor air cooling mode based on the control mode corresponding to the first group.

According to one example, the outdoor air cooling mode may be a mode in which the outdoor air directly flows into the indoor space to perform a cooling function for the indoor space. For example, the server 100 may control the air handling unit to operate in the outdoor air cooling mode by opening a damper of the central air handling unit.

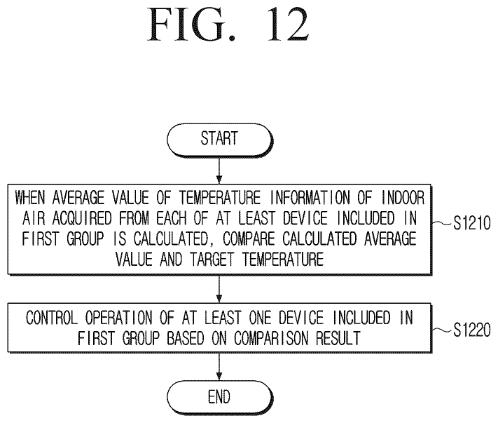

When the outdoor air cooling mode is identified, the server 100 may control the devices included in the first group based on the outdoor air cooling mode. This will be described in detail with reference to FIGS. 12 and 13A to 13D.

The fact that the first enthalpy value exceeds the second enthalpy value indicates that the cooling function for the indoor space may be performed using the outdoor air. The server 100 may efficiently perform the air conditioning operation using the enthalpy value corresponding to the target temperature and the enthalpy value corresponding to the outdoor air.

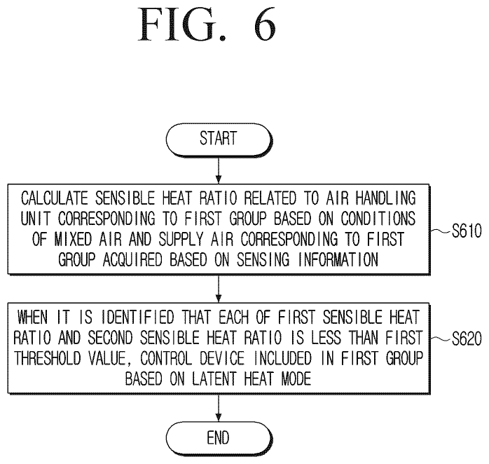

FIG. 6 is a flowchart for describing the method for identifying a control mode according to an embodiment of the disclosure.

Referring to FIG. 6, according to an embodiment, the operating method may include an operation S610 of calculating a sensible heat ratio associated with the air handling unit corresponding to the first group based on the conditions of the mixed air and the supply air corresponding to the first group acquired based on the sensing information.

According to one example, the sensible heat ratio associated with the air handling unit may be the sensible heat ratio of the amount of heat that the cooling coil of the air handling unit should process. According to one example, the server 100 may calculate the sensible heat ratio of the amount of heat that the cooling coil of the air handling unit should process based on the conditions of the mixed air and the supply air. The condition of the air may include the temperature and humidity corresponding to the air.

For example, the server 100 may determine (or acquire) the conditions of the mixed air corresponding to the first group and the supply air corresponding to the first group based on the sensing information. Based on the conditions of the mixed air and the supply air corresponding to the first group, the server 100 may calculate the sensible heat ratio of the amount of heat (or indoor load) that the cooling coil of the air handling unit corresponding to the first group should process.

According to one example, the sensing information may include at least one of temperature information related to mixed air corresponding to the first group, humidity information related to the mixed air, temperature information related to supply air corresponding to the first group, and humidity information related to the supply air. According to one example, the mixed air may be a mixed air of the outdoor air and the indoor air flowing into the air handling unit corresponding to the first group. According to one example, the supply air may be air supplied indoors from the air handling unit corresponding to the first group, or air (e.g., air discharged from a cooling coil included in the air handling unit) discharged from the air handling unit corresponding to the first group.

According to another example, the server 100 may determine the conditions of the mixed air and the supply air corresponding to the first group to calculate the sensible heat ratio of the amount of heat (or indoor load) that the cooling coil of the air handling unit should process. Meanwhile, according to one example, when the indoor air is circulated and then does not flow back into the air handling unit (for example, when the air handling unit is implemented as the outdoor handling unit), the server 100 may calculate the sensible heat ratio based on the temperature information and the humidity information of the outdoor air.

According to an embodiment, the operating method may include an operation S620 of controlling the devices included in the first group based on the latent heat mode when the sensible heat ratio is determined to be less than a first threshold value.

The server 100 may determine whether the calculated sensible heat ratio is less than the first threshold value. According to one example, the first threshold value may be 0.7, but is not limited thereto and may be a different value. According to one example, when the sensible heat ratio is determined to be less than the first threshold value, the server 100 may identify the latent heat mode based on the control mode corresponding to the first group.

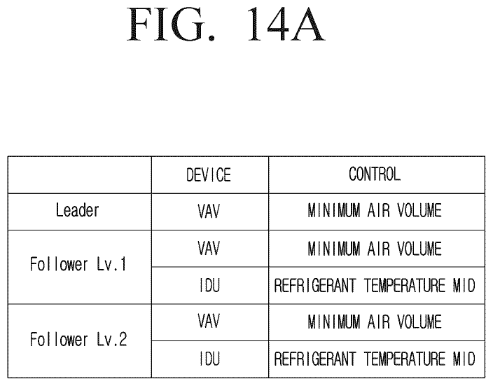

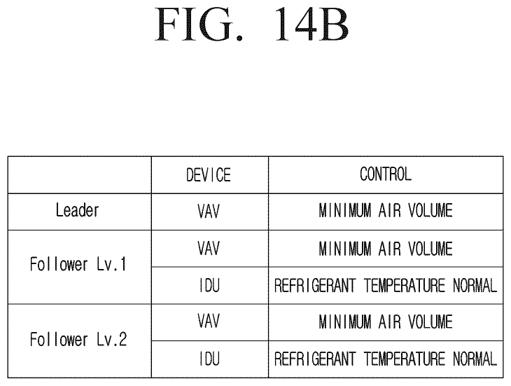

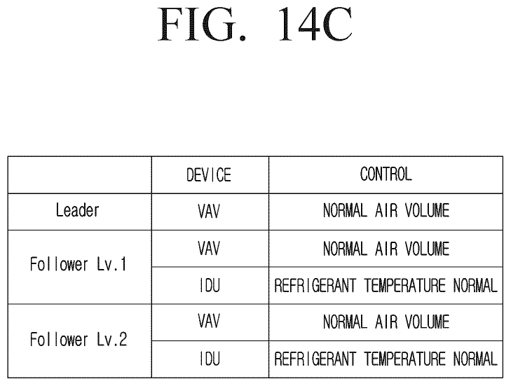

According an embodiment, the latent heat mode is the control mode that focuses on a change in humidity in the indoor space, and may be a mode that controls to lower the sensible heat ratio of the indoor space by removing moisture. According to one example, when the latent heat mode is identified, the server 100 may control the devices included in the first group based on the latent heat mode. This will be described in detail with reference to FIGS. 12 and 14A to 14C.

The low sensible heat ratio indicates a relatively high proportion of latent heat in the air. When it is identified that the sensible heat ratios of the mixed air and the supply air are low, the server may perform air conditioning operation in a mode to lower the humidity in the indoor space. In this case, the server may perform the air conditioning operation efficiently by collectively controlling the identified group.

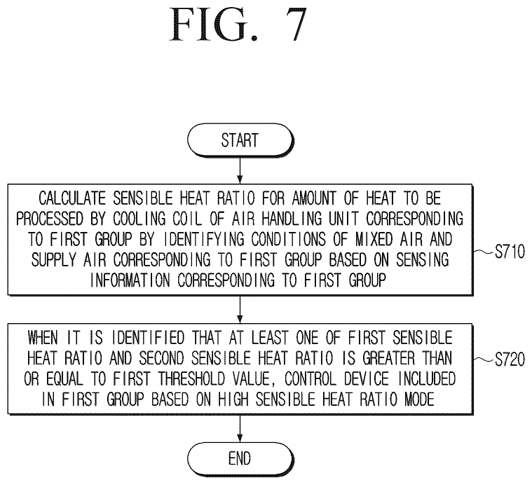

FIG. 7 is a flowchart for describing the method for identifying a control mode according to an embodiment of the disclosure.

Referring to FIG. 7, according to an embodiment, the operating method may include an operation S710 of determining the conditions of the mixed air and the supply air corresponding to the first group based on the sensing information corresponding to the first group, and calculating the sensible heat ratio for the amount of heat to be processed by the cooling coil of the air handling unit corresponding to the first group. According to one example, the server 100 may calculate the sensible heat ratio for the amount of heat to be processed by the cooling coil of the air handling unit corresponding to the first group through the conditions of the mixed air corresponding to the first group and the supply air corresponding to the first group.

According to one example, the sensing information may include at least one of temperature information related to mixed air corresponding to the first group, humidity information related to the mixed air, temperature information related to supply air corresponding to the first group, and humidity information related to the supply air. According to one example, the mixed air may be a mixed air of the outdoor air and the indoor air flowing into the air handling unit corresponding to the first group. According to one example, the supply air may be air supplied indoors from the air handling unit corresponding to the first group, or air (e.g., air discharged from a cooling coil included in the air handling unit) discharged from the air handling unit corresponding to the first group.

The server 100 may calculate the sensible heat ratio based on the temperature information and the humidity information of the mixed air and the temperature information and the humidity information of the supply air. Meanwhile, according to one example, when the indoor air is circulated and then does not flow back into the air handling unit (for example, when the air handling unit is implemented as the outdoor handling unit), the server 100 may calculate the sensible heat ratio based on the temperature information and the humidity information of the outdoor air.

According to an embodiment, the operating method may include an operation S720 of controlling the devices included in the first group based on the high sensible heat mode when it is identified that the sensible heat ratio is greater than or equal to the first threshold value.

The server 100 may determine whether the calculated sensible heat ratio is greater than or equal to the first threshold value. According to one example, the first threshold value may be 0.7, but is not limited thereto and may be a different value. According to one example, when it is identified that the sensible heat ratio is greater than or equal to the first threshold value, the server 100 may identify the high sensible heat mode based on the control mode corresponding to the first group.

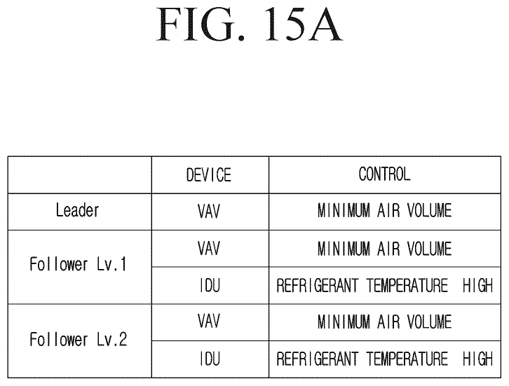

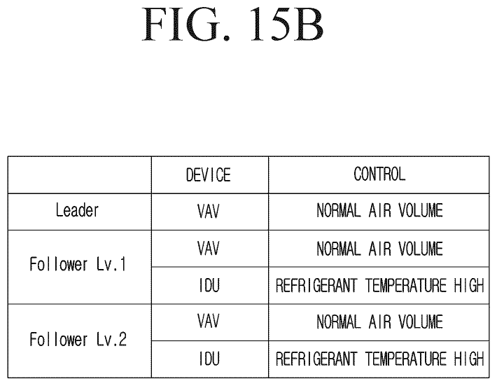

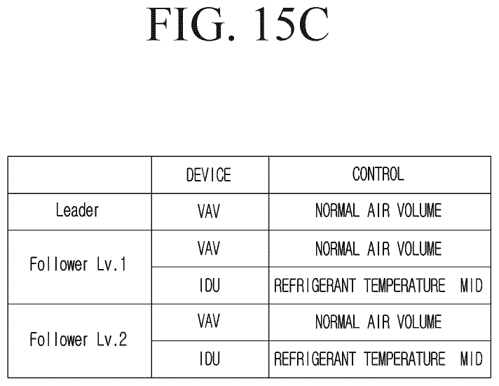

According to another example, the high sensible heat mode is the control mode focused on the change in temperature in the indoor space and may be an operating mode in an environment in which the change in temperature is large and the change in humidity is small. According to one example, the high sensible heat mode may be an operating mode in a dry environment with the high sensible heat ratio. According to one example, when the high sensible heat mode is identified, the server 100 may control the devices included in the first group based on the high sensible heat mode. This will be described in detail with reference to FIGS. 12 and 15A to 15C.

The high sensible heat ratio indicates a relatively high proportion of the sensible heat in the air. When it is determined that the sensible heat ratio of any one of the mixed air and the supply air is high, the server may perform the air conditioning operation in a mode to appropriately maintain the temperature of the indoor space. In this case, the server may efficiently perform the air conditioning operation by collectively controlling the identified group.

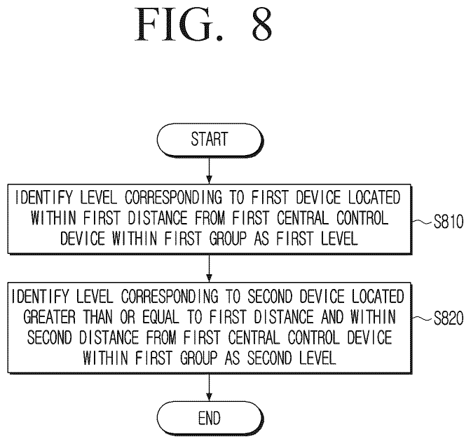

FIG. 8 is a flowchart for describing a method of identifying a level of a device included in a first group according to an embodiment of the disclosure.

Referring to FIG. 8, according to an embodiment, the operating method may include an operation S810 of identifying a level corresponding to the first device located within the first distance from the first central control device within the first group as the first level.

The first group may include at least one device including the first central control device corresponding to the leader device. According to one example, the server 100 may identify devices located within the second distance from the first central control device, among the devices (e.g., the central control device or the individual control devices) arranged in the indoor space, as the first group.

According to another example, the server 100 may identify devices located within the first distance among the devices arranged in the indoor space based on the RSSI value measured from the first central control device. According to one example, the first distance may be less than the second distance. For example, the server 100 may identify the first device whose RSSI value measured from the first central control device is less than a preset value and may identify the identified first device as the first level.

According to an embodiment, the operating method may include an operation S820 of identifying a level corresponding to the second device within the first group that is located greater than or equal to the first distance and within the second distance from the first central control device as the second level.

According to one example, the server 100 may identify the second device within the first group that is located greater than or equal to the first distance and within the second distance from the first central control device, and may identify the level corresponding to the identified second device as the second level.

The server 100 may control the operation of at least one device within the first group based on the identified level. For example, it may be assumed that the control mode corresponding to the first group is identified as the outdoor air cooling mode. The server 100 may control each device within the first group so that an air volume corresponding to the first level device and an air volume corresponding to the second level device are different. This will be described below.

According to one example, when a single device located in the indoor space is included in the plurality of groups, the server 100 may control the single device based on the level corresponding to each of the plurality of groups of the single device. This will be described in detail below with reference to FIG. 9.

FIG. 9 is a flowchart for describing an operation for controlling a device based on a level according to an embodiment of the disclosure.

Referring to FIG. 9, according to an embodiment, when it is identified that the third device arranged in the indoor space is included in the first group and the second group different from the first group, the operating method may include an operation S910 of identifying a level corresponding to the first group and a level corresponding to the second group of the third device, respectively.

According to one example, the server 100 may identify the group to which the third device belongs among at least one device arranged in the indoor space. According to one example, when it is identified that the third device is included in the first group and the second group, the server 100 may identify the level corresponding to the first group of the third device and the level corresponding to the second group of the third device, respectively. According to one example, information on the group and the level corresponding to each of the at least one device arranged in the indoor space may be pre-stored in the memory 120.

According to another embodiment, the operating method may include an operation S920 of controlling the third device based on the control mode corresponding to any one of the first group or the second group when either the first group or the second group is identified based on the identified level.

According to one example, the server 100 may identify any one of the first group or the second group based on the identified levels of the third device corresponding to the first group and the third device corresponding to the second group. According to one example, the server 100 may identify a group with a relatively lower level. For example, when the level of the third device corresponding to the first group is the first level and the level of the third device corresponding to the second group is the second level, the server 100 may identify the first group among the first group and the second group. According to one example, the server 100 may control the third device based on the control mode corresponding to the identified first group.

When the devices arranged in the indoor space are included in the plurality of groups, the server 100 may control the device based on the control mode corresponding to a group with a relatively close distance from the leader device.

When the devices corresponding to each of the plurality of groups have the same level, the server 100 may identify the control mode based on control mode setting values corresponding to each group. This will be described in detail below with reference to FIG. 10.

FIG. 10 is a flowchart for describing a method of identifying one control mode based on a control mode setting value according to an embodiment of the disclosure.

Referring to FIG. 10, according to an embodiment, when it is identified that a fourth device arranged in the indoor space is included in the first group and the second group different from the first group, the operating method may include an operation S1010 of identifying a first control mode corresponding to the first group and a second control mode corresponding to the second group, respectively.

According to an embodiment, the server 100 may identify the group to which the fourth device belongs among at least one device arranged in the indoor space. According to one example, when it is identified that the fourth device is included in the first group and the second group, the server 100 may identify the first control mode corresponding to the first group and the second control mode corresponding to the second group, respectively.

According to one example, the operating method may include an operation S1020 of identifying one control mode based on a setting value corresponding to the first control mode and a setting value corresponding to the second control mode.

According to another embodiment, the server 100 may identify the setting value corresponding to the identified first control mode and the setting value corresponding to the identified second control mode, respectively. According to one example, the server 100 may identify the setting value based on the type of the fourth device, along with the type of the control mode.

For example, when the fourth device is the central control device type, the server 100 may identify the setting value corresponding to the central control device among the setting values corresponding to the first control mode. According to one example, the setting value corresponding to the central control device may be a setting value related to the air volume corresponding to the central control device. According to one example, the server 100 may compare the setting value related to the air volume corresponding to the first control mode with the setting value related to the air volume corresponding to the second control mode, and identify the control mode having a relatively smaller setting value related to the air volume.

Alternatively, when the fourth device is the individual control device type, the server 100 may identify the setting value corresponding to the individual control device among the setting values corresponding to the first control mode. According to one example, the setting value corresponding to the individual control device may be a setting value related to a refrigerant temperature corresponding to the individual control device. According to one example, the server 100 may compare the setting value related to the refrigerant temperature corresponding to the first control mode with the setting value related to the refrigerant temperature corresponding to the second control mode, and identify the control mode corresponding to a relatively higher setting value.

According to another embodiment, the operating method may include an operation S1030 of controlling the fourth device based on one of the identified control modes.

According to an embodiment, when one of the control modes is identified, the server 100 may control the fourth device based on the identified control mode. According to an embodiment, when the first control mode is identified among the first and second control modes, the server 100 may control the fourth device based on the identified first control mode.

Meanwhile, according to an embodiment, the server 100 may identify one of the control modes based on a setting mode corresponding to the indoor space. According to one example, the setting mode corresponding to the indoor space may include, but is not limited to, an “energy saving priority mode” or a “comfort priority mode.”

It may be assumed that the setting mode corresponding to the indoor space is the “energy saving priority mode.” When the setting mode is the “energy saving priority mode,” the server 100 may identify the control mode by preferentially considering the level among the setting value and the level. For example, when the level of the fourth device corresponding to the first group is the first level and the level of the fourth device corresponding to the second group is the second level, the server 100 may control the fourth device based on the control mode corresponding to the first group, which has a relatively lower level, regardless of the setting value.

When the level corresponding to the first group and the level corresponding to the second group are the same, the server 100 may identify the control mode based on the setting value. For example, when the fourth device is the central control device, the server 100 may control the fourth device based on the control mode corresponding to a setting value with a relatively low air volume. Alternatively, for example, when the fourth device is the individual control device, the server 100 may control the fourth device based on the control mode with a relatively high refrigerant temperature.

According to one example, it may be assumed that the setting mode corresponding to the indoor space is a “comfort priority mode.” When the setting mode is the “comfort priority mode,” the server 100 may identify the control mode by giving priority to the setting value among the setting value and the level. For example, when the fourth device is the central control device, the server 100 may control the fourth device based on the control mode corresponding to a setting value with a relatively high air volume. Alternatively, for example, when the fourth device is the individual control device, the server 100 may control the fourth device in the control mode with a relatively low refrigerant temperature.

When the setting value corresponding to the first group and the setting value corresponding to the second group are the same, the server 100 may identify the control mode based on the level. For example, when the level of the fourth device corresponding to the first group is the first level and the level of the fourth device corresponding to the second group is the second level, the server 100 may control the fourth device based on the control mode corresponding to the first group, which has a relatively low level.

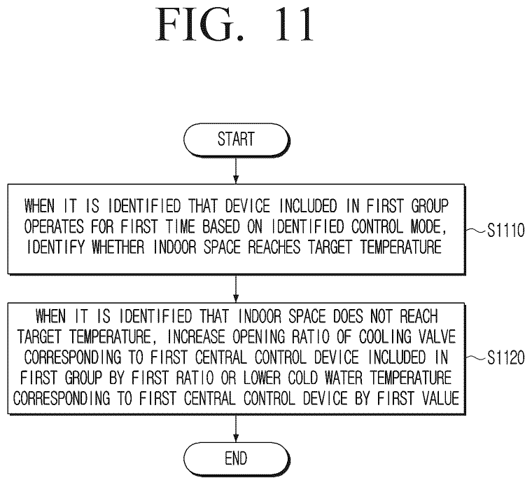

FIG. 11 is a flowchart for describing a method of performing a feedback operation according to an embodiment of the disclosure

Referring to FIG. 11, according to an embodiment, when it is determined that the devices included in the first group operates for a first period of time based on an identified control mode, the operating method may include an operation S1110 of determining whether the indoor space has reached the target temperature.

The server 100 may control the air conditioning operation of the devices included in the first group based on the identified control mode. According to one example, the server 100 may identify the time period during which the devices included in the first group operate in the identified control mode. According to one example, when it is identified that the devices included in the first group operate for the first period of time based on the identified control mode, the server 100 may identify whether the indoor space has reached the target temperature. According to one example, the first period of time may be 15 minutes, but is not limited thereto and may of course be a time of a different magnitude.

According to an embodiment, the operating method may include an operation S1120 of increasing an opening ratio of a cooling valve corresponding to the first central control device included in the first group by a first ratio or lowering cold water temperature corresponding to the first central control device by a first value when it is determined that the target temperature has not been reached.

According to an embodiment, the server 100 may increase the opening ratio of the cooling valve corresponding to the first central control device included in the first group by the first ratio when it is determined that the indoor space has not reached the target temperature. According to one example, the first central control device may be the leader device, but is not limited thereto. According to one example, the cooling valve may be a component included in the air handling unit and may be configured to control the amount of cold water supplied from a chiller to the cooling coil. According to one example, when the indoor space fails to reach the target temperature despite operating in the first control mode for a first period of time, the server 100 may control the air handling unit corresponding to the first central control device to increase the opening ratio of the cooling valve by a first preset ratio.

Alternatively, when it is determined that the indoor space has not reached the target temperature, the server 100 may lower the cold water temperature corresponding to the first central control device included in the first group by the first value. According to one example, the cold water may be a substance supplied from the chiller and may be supplied to the cooling coil from the chiller through the cooling valve. According to one example, when it is determined that the indoor space has not reached the target temperature, the server 100 may control the chiller to lower the cold water temperature by the first value.

FIG. 12 is a flowchart for describing a method of controlling a device based on an average value of temperature information of indoor air according to an embodiment of the disclosure.

Referring to FIG. 12, according to an embodiment, the operating method may include an operation S1210 of calculating an average value of the temperature information of the indoor air acquired from each of at least one device included in the first group, and comparing the calculated average value with the target temperature.

The sensing information corresponding to the first group may include the temperature information of the indoor air sensed from each of at least one device included in the first group. According to one example, the server 100 may calculate the average value of the temperature information of the indoor air acquired from each of at least one device included in the first group. According to one example, the server 100 may compare the calculated average value with the target temperature.

According to one embodiment, the operating method may include an operation S1220 of controlling the operation of at least one device included in the first group based on the comparison result.

According to one example, the server 100 may control the operation of at least one device included in the first group based on a difference between the average value of the temperature information of the indoor air and the target temperature. According to one example, when the control mode corresponding to the first group is identified, the server 100 may identify the setting value related to the operation of each device within the identified control mode based on the difference between the average value and the target temperature, and control each device based on the identified setting value. This will be described in detail below with reference to FIGS. 13A to 13D, 14A to 14C, and 15 A to 15C.

FIGS. 13A, 13B, 13C, and 13D are diagrams for describing a control method in an outdoor air cooling mode according to an embodiment of the disclosure.

Referring to FIGS. 13A to 13D, according to an embodiment, when the outdoor air cooling mode is identified as the control mode corresponding to the first group, the server 100 may compare the average value of the temperature information of indoor air acquired from each of at least one device included in the first group with the target temperature. Meanwhile, according to an example, ‘Leader’ illustrated in FIGS. 13A to 13D, 14A to 14C, and 15A to 15C may refer to a leader device, a ‘Follower Lv. 1’ device may refer to a device corresponding to the first level, a ‘Follower Lv. 2’ device may refer to a device corresponding to the second level, ‘VAV’ may refer to the central control device, and ‘IDU’ may refer to the individual control device.

According to one example, when it is determined that the target temperature is higher than the average value, the server 100 may control the devices included in the first group as illustrated in FIG. 13A. According to one example, the server 100 may control the leader device corresponding to the first group to operate at a ‘minimum air volume’. According to one example, the server 100 may control the central control device corresponding to the first level within the first group to operate at the ‘minimum air volume’. According to one example, the server 100 may control the individual control devices corresponding to the first level within the first group to be turned off. According to one example, the server 100 may control the central control device corresponding to the second level within the first group to operate at the ‘minimum air volume’. The server 100 may control the individual control devices corresponding to the second level within the first group to be turned off.

According to one example, when it is identified that a value obtained by adding the target temperature and a third value is greater than or equal to the average value, the server 100 may control the devices included in the first group as illustrated in FIG. 13B. According to one example, the third value may be, but is not limited to, 1° C. According to one example, the server 100 may control the leader device corresponding to the first group to operate at a ‘normal air volume’. According to one example, the server 100 may control the central control device corresponding to the first level within the first group to operate at the ‘normal air volume’. According to an embodiment, the server 100 may control the individual control devices corresponding to the first level within the first group to be turned off. According to one example, the server 100 may control the central control device corresponding to the second level within the first group to operate at the ‘normal air volume’. According to one example, the server 100 may control the individual control devices corresponding to the second level within the first group to be turned off.

According to one example, when it is identified that the target temperature plus a fourth value is greater than or equal to the average value, the server 100 may control the devices included in the first group as illustrated in FIG. 13C. According to one example, the fourth value may be a value exceeding the third value, such as 2° C., but is not limited thereto. According to one example, the server 100 may control the leader device corresponding to the first group to operate at a ‘minimum air volume’. According to one example, the server 100 may control the central control device corresponding to the first level within the first group to operate at the ‘minimum air volume’. According to one example, the server 100 may control the refrigerant temperature corresponding to the individual control devices corresponding to the first level within the first group to be “high.” According to one example, “high” may refer to a temperature that is relatively high compared to a median value of the refrigerant temperature corresponding to the outdoor air cooling mode, but is not limited thereto. According to another example, the server 100 may control the central control device corresponding to the second level within the first group to operate at the ‘minimum air volume’. According to one example, the server 100 may control the refrigerant temperature corresponding to the individual control devices corresponding to the second level within the first group to be “high.”

According to one example, when it is identified that a value obtained by adding the target temperature and the fourth value is less than the average value, the server 100 may control the devices included in the first group as illustrated in FIG. 13D. According to one example, the server 100 may control the leader device corresponding to the first group to operate at the ‘normal air volume’. According to one example, the server 100 may control the central control device corresponding to the first level within the first group to operate at the ‘normal air volume’. According to one example, the server 100 may control the refrigerant temperature corresponding to the individual control devices corresponding to the first level within the first group to be “mid.” The ‘mid’ may mean, but is not limited to, the middle value of the refrigerant temperature corresponding to the outdoor air cooling mode. According to one example, the server 100 may control the central control device corresponding to the second level within the first group to operate at the ‘normal air volume’. According to one example, the server 100 may control the refrigerant temperature corresponding to the individual control devices corresponding to the second level within the first group to be “mid.”

FIGS. 14A, 14B, and 14C are diagrams illustrating a control method in a latent heat mode according to various embodiments of the disclosure.

Referring to FIGS. 14A to 14C, according to an embodiment, when the latent heat mode is identified as the control mode corresponding to the first group, the server 100 may compare the average value of the temperature information of indoor air acquired from each of at least one device included in the first group with the target temperature.

According to one example, when it is identified that the value obtained by adding the target temperature and the third value is greater than or equal to the average value, the server 100 may control the devices included in the first group as illustrated in FIG. 14A. According to one example, the third value may be, but is not limited to, 1° C. According to one example, the server 100 may control the leader device corresponding to the first group to operate at a ‘minimum air volume’. According to one example, the server 100 may control the central control device corresponding to the first level within the first group to operate at the ‘minimum air volume’. According to one example, the server 100 may control the refrigerant temperature corresponding to the individual control devices corresponding to the first level within the first group to be “mid.” The ‘mid’ may mean, but is not limited to, the middle value of the refrigerant temperature corresponding to the latent heat mode. According to one example, the server 100 may control the central control device corresponding to the second level within the first group to operate at the ‘minimum air volume’. According to one example, the server 100 may control the refrigerant temperature corresponding to the individual control devices corresponding to the second level within the first group to be “mid.”

According to one example, when it is identified that the value obtained by adding the target temperature and the fourth value is greater than or equal to the average value, the server 100 may control the devices included in the first group as illustrated in FIG. 14B. According to one example, the fourth value may be a value exceeding the third value, such as 2° C., but is not limited thereto. According to one example, the server 100 may control the leader device corresponding to the first group to operate at the ‘minimum air volume’. According to another example, the server 100 may control the central control device corresponding to the first level within the first group to operate at the ‘minimum air volume’. According to one example, the server 100 may control the refrigerant temperature corresponding to the individual control devices corresponding to the first level within the first group to be “normal.” According to one example, the ‘normal’ may mean a general refrigerant temperature corresponding to the latent heat mode. The server 100 may control the central control device corresponding to the second level within the first group to operate at the ‘minimum air volume’. According to one example, the server 100 may control the refrigerant temperature corresponding to the individual control devices corresponding to the second level within the first group to be “normal.”

According to one example, when it is identified that the value obtained by adding the target temperature and the fourth value is less than the average value, the server 100 may control the devices included in the first group as illustrated in FIG. 14C. According to one example, the server 100 may control the leader device corresponding to the first group to operate at the ‘normal air volume’. According to one example, the server 100 may control the central control device corresponding to the first level within the first group to operate at the ‘normal air volume’. According to an embodiment, the server 100 may control the refrigerant temperature corresponding to the individual control devices corresponding to the first level within the first group to be “normal.” According to one example, the server 100 may control the central control device corresponding to the second level within the first group to operate at the ‘normal air volume’. According to one example, the server 100 may control the refrigerant temperature corresponding to the individual control devices corresponding to the second level within the first group to be “normal.”

FIGS. 15A, 15B, and 15C are diagrams for describing a control method in a high sensible heat mode according to various embodiments of the disclosure.

Referring to FIGS. 15A to 15C, according to an embodiment, when the high sensible heat mode is identified as the control mode corresponding to the first group, the server 100 may compare the average value of the temperature information of indoor air acquired from each of at least one device included in the first group with the target temperature.

According to one example, when it is identified that the value obtained by adding the target temperature and the third value is greater than or equal to the average value, the server 100 may control the devices included in the first group as illustrated in FIG. 15A. According to one example, the third value may be, but is not limited to, 1° C. According to one example, the server 100 may control the leader device corresponding to the first group to operate at the ‘minimum air volume’. According to one example, the server 100 may control the central control device corresponding to the first level within the first group to operate at the ‘minimum air volume’. The server 100 may control the refrigerant temperature corresponding to the individual control devices corresponding to the first level within the first group to be “high.” According to one example, “high” may refer to a value higher than the median refrigerant temperature corresponding to the high sensible heat mode, but is not limited thereto. According to one example, the server 100 may control the central control device corresponding to the second level within the first group to operate at the ‘minimum air volume’. The server 100 may control the refrigerant temperature corresponding to the individual control devices corresponding to the second level within the first group to be “high.”

According to one example, when it is identified that the value obtained by adding the target temperature and the fourth value is greater than or equal to the average value, the server 100 may control the devices included in the first group as illustrated in FIG. 15B. According to one example, the fourth value may be a value exceeding the third value, such as 2° C., but is not limited thereto. According to one example, the server 100 may control the leader device corresponding to the first group to operate at the ‘normal air volume’. According to another example, the server 100 may control the central control device corresponding to the first level within the first group to operate at the ‘normal air volume’. According to one example, the server 100 may control the refrigerant temperature corresponding to the individual control devices corresponding to the first level within the first group to be “high.” According to one example, the server 100 may control the central control device corresponding to the second level within the first group to operate at the ‘normal air volume’. According to one example, the server 100 may control the refrigerant temperature corresponding to the individual control devices corresponding to the second level within the first group to be “high.”

When it is identified that the value obtained by adding the target temperature and the fourth value is less than the average value, the server 100 may control the devices included in the first group as illustrated in FIG. 15C. According to one example, the server 100 may control the leader device corresponding to the first group to operate at the ‘normal air volume’. According to one example, the server 100 may control the central control device corresponding to the first level within the first group to operate at the ‘normal air volume’. According to one example, the server 100 may control the refrigerant temperature corresponding to the individual control devices corresponding to the first level within the first group to be “mid.” According to an embodiment, “mid” may refer to a median value of the refrigerant temperature corresponding to the high sensible heat mode, but is not limited thereto. According to one example, the server 100 may control the central control device corresponding to the second level within the first group to operate at the ‘normal air volume’. According to one example, the server 100 may control the refrigerant temperature corresponding to the individual control devices corresponding to the second level within the first group to be “mid.”

FIG. 16 is a flowchart for describing a method of identifying a first group according to an embodiment of the disclosure.

Referring to FIG. 16, according to an embodiment, the operating method may include an operation S1610 of identifying, for each of the central control device and the individual control devices arranged in the indoor space, the received signal strength indicator (RSSI) value measured by the first central control device arranged in the indoor space.

The server may measure the signal strength reaching the first central control device from each of the central control devices and the individual control devices arranged in the indoor space. According to one example, the server may identify the received signal strength indicator (RSSI) value measured by the first central control device for each device.

In an embodiment, the operating method may include an operation S1620 of identifying devices with an identified RSSI value greater than or equal to a second value as the first group.

According to one example, the server may identify devices with an RSSI value greater than or equal to the second value as the first group. According to another example, the server may identify a device with a value greater than or equal to the second value as a device corresponding to the first level when it is also greater than or equal to the third value, and identify a device with a value less than the third value as a device corresponding to the second level.

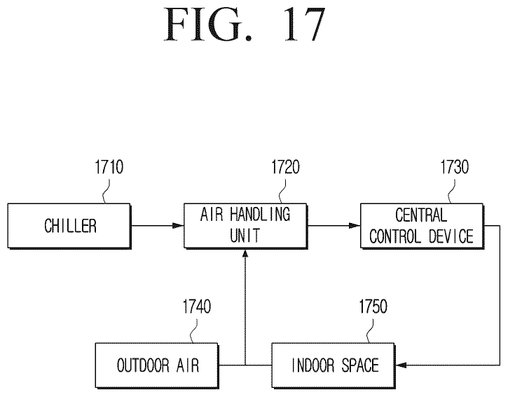

FIG. 17 is a block diagram for describing a central air conditioning system type device according to an embodiment of the disclosure.

Referring to FIG. 17, according to an embodiment, the central air conditioning system corresponding to the central control device may include a chiller 1710, an air handling unit 1720, and a central control device 1730. According to one example, it should be understood that the central air conditioning system may include configurations other than those illustrated in FIG. 17.

According to one example, the chiller 1710 may supply cold water to the air handling unit 1720. According to one example, the server 100 may control the chiller 1710 to adjust the temperature of the cold water supplied to the air handling unit 1720.

The air handling unit 1720 may supply the temperature- or humidity-controlled air to the indoor space 1750 using the cold water supplied from the chiller. According to one example, the outdoor air 1740 may be introduced from an outdoor space into the air handling unit 1720. According to one example, the indoor air may be introduced from the indoor space 1750 into the air handling unit 1720. According to one example, the air handling unit 1720 may control the temperature or humidity of the mixed air, including the indoor air and the outdoor air 1740, through the cooling coil and supply the temperature or humidity to the central control device 1730.

According to another example, the air discharged from the air handling unit 1720 may flow into the central control device 1730. The central control device 1730 may control the amount of air introduced from the air handling unit 1720.

FIG. 18 is a block diagram illustrating a detailed configuration of a server according to an embodiment of the disclosure.

According to FIG. 18, a server 100′ may include at least one processor 110, memory 120, a display 130, a user interface 140, a communication circuit 150, a speaker 160, a microphone 170, and at least one sensor 180. A detailed description for components overlapped with components illustrated in FIG. 2 among components illustrated in FIG. 18 will be omitted.

The display 130 may be implemented as a display including a self-light emitting element or a display including a non-light emitting element and a backlight. For example, the display 130 may be implemented as various types of displays such as a liquid crystal display (LCD), an organic light emitting diodes (OLED) display, light emitting diodes (LED), a micro LED, a Mini LED, a plasma display panel (PDP), a quantum dot (QD) display, and quantum dot light-emitting diodes (QLED). A driving circuit, a backlight unit, and the like, that may be implemented in a form such as a-si TFT, low temperature poly silicon (LTPS) TFT, an organic TFT (OTFT), and the like, may be included in the display 130. The display 130 may be implemented as a touch screen coupled with a touch sensor, a flexible display, a rollable display, a 3D display, a display to which a plurality of display modules are physically connected, and the like. The processor 110 may control the display 130 to output the output image obtained according to various embodiments described above. Here, the output image may be a high-resolution image of 4K or 8K or higher. The output image may also be a game image according to an embodiment.

According to an embodiment, the display 130 may include a plurality of haptic elements. The haptic element may be implemented as a motor for providing haptic feedback (e.g., vibration feedback) to a user, but is not limited thereto. According to one example, the display 130 may include the preset number of haptic elements. For example, the display 130 may include the preset number of haptic elements corresponding to the preset number of sub-regions of the display, but is not limited thereto, and it goes without saying that the display may include the number of haptic elements different from the number of sub-regions corresponding to the display.

The user interface 140 is a component for the server 100′ to perform an interaction with a user. In an example, the user interface 140 may include at least one of a touch sensor, a motion sensor, a button, a jog dial, a switch, a microphone, or a speaker, but is not limited thereto.

The communication circuit 150 may input and output various types of data. For example, the communication circuit 150 may transmit and receive various types of data to and from an external device (e.g., source device), an external storage medium (e.g., USB memory), an external server (e.g., web hard), etc., through communication methods such as AP-based Wi-Fi (wireless LAN network), Bluetooth, Zigbee, a wired/wireless local area network (LAN), a wide area network (WAN), Ethernet, IEEE 1394, a high-definition multimedia interface (HDMI), a universal serial bus (UBS), a mobile high-definition link (MHL), an audio engineering society/European broadcasting union (AES/EBU), optical, and coaxial.

The communication circuit 150 may include Bluetooth low energy (BLE) module. The BLE refers to Bluetooth technology that enables low-power, low-capacity data transmission and reception in the 2.4 GHz frequency band with a range of approximately 10 meters. However, the disclosure is not limited thereto, and the communication circuit 150 may also include a Wi-Fi communication module. That is, the communication circuit 150 may include at least one of the Bluetooth low energy (BLE) module and the Wi-Fi communication module.

According to an embodiment, the speaker 160 may include a tweeter for high-pitched sound reproduction, a mid-range sound for mid-range sound reproduction, a woofer for low-pitched sound reproduction, a subwoofer for extremely low-pitched sound reproduction, an enclosure for controlling resonance, a crossover network that divides an electric signal frequency input to the speaker by band, etc.

The speaker 160 may output acoustic signals to the outside of the server 100′. The speaker 160 may output multimedia reproduction, recording reproduction, various kinds of notification sounds, voice messages, and the like. The server 100′ may include an audio output device such as the speaker 160, or may include an output device such as an audio output terminal. In particular, the speaker 160 may provide acquired information, information processed/produced based on the acquired information, a response result to a user's voice, an operation result, or the like in the form of voice.

The microphone 170 may refer to a module that acquires sound and converts the acquired sound into an electrical signal, and may be a condenser microphone, a ribbon microphone, a moving coil microphone, a piezoelectric element microphone, a carbon microphone, or a micro electro mechanical system (MEMS) microphone. In addition, the microphone 170 may be implemented in non-directional, bi-directional, unidirectional, sub cardioid, super cardioid, and hyper cardioid methods. According to an embodiment, the server 100′ may include the microphone 170 and an inner microphone, and the microphone 170 may be a microphone positioned relatively outside a body. The server 100′ may acquire an audio signal including external noise through the microphone 170. According to an embodiment, the microphone 170 may be positioned in a direction opposite to the direction in which the speaker 160 emits sound.

According to another embodiment, at least one sensor 180 may include a lens for focusing visible light and other optical signals received after being reflected by an object into an image sensor, and an image sensor capable of detecting visible light and other optical signals. Here, the image sensor may include a 2D pixel array divided into a plurality of pixels. According to one example, at least one sensor 180 may be a stereo camera implemented as an infrared (IR) camera or a red, green, blue (RGB) camera, but is not limited thereto, and the camera sensor may of course be implemented as a different type of sensor (for example, a Lidar sensor).

At least one sensor 180 may be implemented as a different type of sensor, including a Lidar sensor, an ultrasonic sensor, an acceleration sensor, an angular velocity sensor, and a gyro sensor. According to an example, at least one sensor 180 may include an RGB sensor. However, the disclosure is not limited thereto, and at least one sensor 180 may include a different type of sensor.

According to the above-described example, when multiple types of air handling units (e.g., the central air conditioning system and the split system air conditioner) are installed in the indoor space, the server 100′ groups the air handling unit and sets the control mode corresponding to each group based on information acquired from each group, thereby performing the air conditioning function more efficiently than when each air handling unit operates independently.

According to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the display apparatus (for example, the display apparatus A) according to the disclosed embodiments. In the case in which a command is executed by the processor, the processor may perform a function corresponding to the command directly or using other components under a control of the processor. The command may include codes provided or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment, the above-described methods according to the diverse embodiments may be included and provided in a computer program product. The computer program product may be traded as a product between a seller and a purchaser. The computer program product may, for example, be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as memory of a server of a manufacturer, a server of an application store, or a relay server or be temporarily provided.

In addition, each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A server, comprising:
processing circuitry;
memory, comprising one or more storage media, storing instructions; and
at least one processor communicatively coupled to the processing circuitry and the memory,
wherein the instructions, when executed by the at least one processor individually or collectively, cause the server to:
identify a central control device and at least one individual control device arranged in an indoor space as at least one group,
identify a control mode corresponding to a first group among the identified at least one group, based on sensing information corresponding to the first group and a target temperature corresponding to the indoor space, and
control a device included in the first group based on the identified control mode.

2. The server as claimed in claim 1,
wherein the sensing information includes at least one of temperature information and humidity information of outdoor air corresponding to the first group, and
wherein the instructions, when executed by the at least one processor individually or collectively, further cause the server to:
identify a first enthalpy value based on the target temperature, and a second enthalpy value based on the sensing information, respectively, and
based on the identified first enthalpy value being greater than the identified second enthalpy value, control the device included in the first group to correspond to an outdoor air cooling mode.

3. The server as claimed in claim 1,
wherein the sensing information includes at least one of temperature information related to mixed air corresponding to the first group, humidity information related to the mixed air, temperature information related to supply air corresponding to the first group, and humidity information related to the supply air, and
wherein the instructions, when executed by the at least one processor individually or collectively, further cause the server to:
obtain sensible heat ratio of an amount of heat processed by a cooling coil of an air handling unit corresponding to the first group based on the sensing information, and
based on the sensible heat ratio being less than a first threshold value, control the device included in the first group to correspond to a latent heat mode,
wherein the mixed air is a mixture of outdoor air and indoor air flowing into the air handling unit corresponding to the first group, and
wherein the supply air is air discharged from the air handling unit corresponding to the first group.

4. The server as claimed in claim 1,
wherein the sensing information includes at least one of temperature information related to mixed air corresponding to the first group, humidity information related to the mixed air, temperature information related to supply air corresponding to the first group, and humidity information related to the supply air, and
wherein the instructions, when executed by the at least one processor individually or collectively, further cause the server to:
obtain sensible heat ratio of an amount of heat processed by a cooling coil of an air handling unit corresponding to the first group, based on the sensing information corresponding to the first group, and
based on the sensible heat ratio being greater than or equal to a first threshold value, control the device included in the first group to correspond to a high sensible heat mode,
wherein the mixed air is a mixture of outdoor air and indoor air flowing into the air handling unit corresponding to the first group, and
wherein the supply air is air discharged from the air handling unit corresponding to the first group.

5. The server as claimed in claim 1,
wherein the first group includes a first central control device, and
wherein the instructions, when executed by the at least one processor individually or collectively, further cause the server to:
identify a level corresponding to a first device located within a first distance from the first central control device in the first group as a first level, and
identify a level corresponding to a second device, located at a distance greater than or equal to the first distance and within a second distance from the first central control device in the first group, as a second level.

6. The server as claimed in claim 1, wherein the instructions, when executed by the at least one processor individually or collectively, further cause the server to:
based on a third device located in the indoor space being included in the first group and a second group different from the first group, identify a level corresponding to the first group of the third device and a level corresponding to the second group of the third device, respectively; and
control the third device based on a control mode corresponding to the group of a higher level among the first group and the second group,
wherein the level corresponds to a distance from the central control device.

7. The server as claimed in claim 1, wherein the instructions, when executed by the at least one processor individually or collectively, further cause the server to:
based on a fourth device located in the indoor space being included in the first group and a second group different from the first group, identify a first control mode corresponding to the first group and a second control mode corresponding to the second group, respectively;
identify setting element corresponding to a type of the fourth device based on the type of the fourth device;
identify a control mode corresponding to the fourth device based on a first setting value of the setting element corresponding to the first control mode and a second setting value of the setting element corresponding to the second control mode; and
control the fourth device based on the identified control mode corresponding to the fourth device.

8. The server as claimed in claim 1, wherein the instructions, when executed by the at least one processor individually or collectively, further cause the server to:
based on the device included in the first group operating for a predetermined time based on the identified control mode, identify whether the indoor space has reached the target temperature; and
based on the target temperature not having been reached, increase an opening ratio of a cooling valve corresponding to a first central control device included in the first group by a first ratio or decrease cold water temperature corresponding to the first central control device by a first value.

9. The server as claimed in claim 1,
wherein the sensing information corresponding to the first group includes temperature information of indoor air obtained from each of at least one device included in the first group, and
wherein the instructions, when executed by the at least one processor individually or collectively, further cause the server to:
based on an average value of the temperature information of the indoor air obtained from each of at least one device included in the first group and the target temperature, control an operation of at least one device included in the first group.

10. The server as claimed in claim 1, wherein the instructions, when executed by the at least one processor individually or collectively, further cause the server to:
identify, for each of the at least one individual control device, a received signal strength indicator (RSSI) value measured by the central control device arranged in the indoor space; and
identify the at least one individual device as a device included in a group including the central control device based on the identified RSSI value for the at least one individual device being greater than or equal to a second value.

11. A method of operating a server, the method comprising:
identifying a central control device and at least one individual control device arranged in an indoor space as at least one group;
identifying a control mode corresponding to a first group among the identified at least one group, based on sensing information corresponding to the first group and a target temperature corresponding to the indoor space; and
controlling a device included in the first group based on the identified control mode.

12. The method of claim 11,
wherein the sensing information includes at least one of temperature information and humidity information of outdoor air corresponding to the first group, and
wherein the operating method further includes:
identifying a first enthalpy value based on the target temperature and a second enthalpy value based on the sensing information, respectively, and
based on the identified first enthalpy value being greater than the identified second enthalpy value, controlling the device included in the first group to correspond to an outdoor air cooling mode.

13. The method of claim 11,
wherein the sensing information includes at least one of temperature information related to mixed air corresponding to the first group, humidity information related to the mixed air, temperature information related to supply air corresponding to the first group, and humidity information related to the supply air,
wherein the operating method further includes:
obtaining sensible heat ratio of an amount of heat processed by a cooling coil of an air handling unit corresponding to the first group based on the sensing information, and
based on the sensible heat ratio being less than a first threshold value, controlling the device included in the first group to correspond to a latent heat mode,
wherein the mixed air is a mixture of outdoor air and indoor air flowing into the air handling unit corresponding to the first group, and
wherein the supply air is air discharged from the air handling unit corresponding to the first group.

14. The method of claim 11,
wherein the sensing information includes at least one of temperature information related to mixed air corresponding to the first group, humidity information related to the mixed air, temperature information related to supply air corresponding to the first group, and humidity information related to the supply air, and
wherein the operating method further includes:
obtaining sensible heat ratio of an amount of heat processed by a cooling coil of an air handling unit corresponding to the first group, based on the sensing information corresponding to the first group, and
based on the sensible heat ratio being greater than or equal to a first threshold value, controlling the device included in the first group to correspond to a high sensible heat mode,
wherein the mixed air is a mixture of outdoor air and indoor air flowing into the air handling unit corresponding to the first group, and
wherein the supply air is air discharged from the air handling unit corresponding to the first group.

15. The method of claim 11, wherein the first group includes a first central control device, and
wherein the operating method further includes:
identifying a level corresponding to a first device located within a first distance from the first central control device in the first group as a first level, and
identifying a level corresponding to a second device, located at a distance greater than or equal to the first distance and within a second distance from the first central control device in the first group, as a second level.

16. The method of claim 11, further includes:
based on a third device located in the indoor space being included in the first group and a second group different from the first group, identifying a level corresponding to the first group of the third device and a level corresponding to the second group of the third device, respectively; and
controlling the third device based on a control mode corresponding to the group of a higher level among the first group and the second group,
wherein the level corresponds to a distance from the central control device.

17. The method of claim 11, further includes:
based on a fourth device located in the indoor space being included in the first group and a second group different from the first group, identifying a first control mode corresponding to the first group and a second control mode corresponding to the second group, respectively;
identifying setting element corresponding to a type of the fourth device based on the type of the fourth device;
identifying a control mode corresponding to the fourth device based on a first setting value of the setting element corresponding to the first control mode and a second setting value of the setting element corresponding to the second control mode; and
controlling the fourth device based on the identified control mode corresponding to the fourth device.

18. The method of claim 11, further includes:
based on the device included in the first group operating for a predetermined time based on the identified control mode, identifying whether the indoor space has reached the target temperature; and
based on the target temperature not having been reached, increasing an opening ratio of a cooling valve corresponding to a first central control device included in the first group by a first ratio or decreasing cold water temperature corresponding to the first central control device by a first value.

19. The method of claim 11, wherein the sensing information corresponding to the first group includes temperature information of indoor air obtained from each of at least one device included in the first group, and
wherein the operating method further includes:
based on an average value of the temperature information of the indoor air obtained from each of at least one device included in the first group and the target temperature, controlling an operation of at least one device included in the first group.

20. One or more non-transitory computer-readable storage media storing one or more computer programs including computer-executable instructions that, when executed by at least one processor of a server individually or collectively, cause the server to perform operations, the operations comprising:
identifying a central control device and at least one individual control devices arranged in an indoor space as at least one group;
identifying a control mode corresponding to a first group among the identified at least one group, based on sensing information corresponding to the first group and a target temperature corresponding to the indoor space; and
controlling a device included in the first group based on the identified control mode.
